(19) United States
(12) Patent Application Publication
(10) Pub. No.: US 2009/0068518 A1
(43) Pub. Date: Mar. 12, 2009

(54) PASSIVE FUEL CELL SYSTEM

(75) Inventors: Ku-Yen Kang, Hsinchu City (TW); Ying-Ying Hsu, Kaohsiung City (TW); Chiou-Chu Lai, Hsinchu County (TW); Yin-Wen Tsai, Nantou County (TW); Chun-Ho Tai, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: INDUSTRIAL TECHNOLOGY RESEARCH INSTITUTE, Hsinchu (TW)

(21) Appl. No.: 12/111,937

(22) Filed: Apr. 29, 2008

(30) Foreign Application Priority Data
Sep. 10, 2007 (TW) 96133672

(51) Int. Cl. H01M 8/02

(52) U.S. Cl. 429/26; 429/12

(57) ABSTRACT

A passive fuel cell system including at least one cell unit, an anode fuel supplying unit, a cathode fuel supplying unit, and a heat-conductive material layer is provided. The cell unit includes a cathode current collector, an anode current collector, and a membrane electrode assembly disposed between them. The anode fuel supplying unit is disposed on a side of the anode current collector, and the cathode fuel supplying unit is disposed on a side of the cathode current collector. The heat-conductive material layer is disposed between the cathode current collector and the cathode fuel supplying unit and/or between the anode current collector and the anode fuel supplying unit. And, a portion of the heat-conductive material layer extends to the outside of a cell system reaction area defined by the cell unit, the anode fuel supplying unit, and the cathode fuel supplying unit along a direction parallel to the cell unit.

### CROSS-REFERENCE TO RELATED APPLICATION

This application claims the priority benefit of Taiwan application serial no. 96133672, filed on Sep. 10, 2007. The entirety the above-mentioned patent application is hereby incorporated by reference herein and made a part of specification.

### BACKGROUND OF THE INVENTION

1. Field of the Invention

The present invention relates to a fuel cell system. More particularly, the present invention relates to a passive fuel cell system having a heat conductive element.

2. Description of Related Art

Fuel cells are becoming an attractive replacement for traditional power supplies since the fuel cells can be continually replenished with fuel and are able to provide a continuous supply of electric power, and are highly efficient as compared with the conventional secondary batteries e.g. Li batteries and NiMH batteries.

Among others, direct methanol fuel cells (DMFCs) are one of the fuel cells most commonly seen in the industry. DMFCs generate electricity directly using aqueous methanol solution as a fuel through relevant electrode reactions of methanol and oxygen. To meet the application and development of portable electronic products, such as mobile phones, laptop computers, and digital cameras, DMFCs are mainly classified into active and passive cells.

Generally speaking, the active fuel cells need a pump to drive the anode fuel circulation so as to discharge the generated carbon dioxide. In another aspect, a fan or compressor is needed to force the air to circulate so as to provide the oxygen required by the cathode. It is known from the above that the active fuel cell uses many energy-consuming elements, so the net electricity output of the system is reduced, and the components are complicated and occupy more space.

Moreover, the passive fuel cells transfer fuel and air to the surface of the electrodes for reaction mainly based on gravity, capillarity, or natural diffusion, and work at a relatively lower temperature, for example the room temperature. As the passive fuel cells do not use energy-consuming elements such as the pumps, fans, or compressors, the manufacturing cost is lower, and the elements can be easily made smaller. Therefore, the passive fuel cells are more applicable to portable electronic products, which is the breakthrough to reduce the overall volume.

However, the anode fuel of the passive fuel cells can be methanol vapors. When the methanol liquid is vaporized to become methanol vapors, the ambient temperature and pressure will greatly influence the vaporization amount of methanol. Normally, waste heat is continually generated in the period of the working of fuel cells. If the waste heat cannot be dissipated effectively, the system temperature continuously rises to cause an increasing vaporization amount of the methanol fuel, leading to a vicious circle. Meanwhile, when the working temperature of the passive fuel cell is too high, the over-high concentration of the methanol vapor fuel will incur the crossover effect of methanol, which lowers the output power, and reduces the lifespan of the cell.

Japanese Patent Gazette WO 2006/101071A1 discloses a fuel cell, in which protrusions are formed on a surface of a cathode, so as to transfer heat from the inside to the outside of the cell. In this circumstance, the transmission path of most heat is perpendicular to the surface of the cell, such that the heat transmitted to the air side is radiated to the air from the surfaces of the protrusions. Thus, the fuel supply of the cathode side will be influenced, which further leads to the reduction of the performance of the cell elements. In addition, the area that mostly requires temperature control in the passive fuel system is the vapor fuel supplying end of the anode. However, the above design will directly lower the temperature of a membrane electrode assembly (MEA), so the output power of the MEA is greatly influenced. Furthermore, the volume of the entire system will be increased, and the fabrication will become more complicated. In addition, early publication of US Patent Application No. 2006/0035124 also discloses a fuel cell system and the relevant technology of a heat dissipation equipment of the fuel cell system. However, the method provided in this US patent cannot effectively solve the above-mentioned problems. Therefore, the two patents are both incorporated by references in the present invention.

In view of the above, the temperature control of a passive fuel cell is vital to the stability of the system, and is a key technology that influences the output power of the fuel cell. Therefore, it has become an important subject for the industry to manage and control the temperature of the fuel cell.

### SUMMARY OF THE INVENTION

Accordingly, the present invention is directed to a passive fuel cell system, which solves the problems induced by the waste heat that cannot effectively dissipated in the conventional arts, such that the fuel cell keeps working in a stable working temperature range.

The present invention provides a passive fuel cell system, including at least one cell unit, a cathode fuel supplying unit, an anode fuel supplying unit, and a heat-conductive material layer. A cell system reaction area is defined by the cell unit, the anode fuel supplying unit, and the cathode fuel supplying unit. Each of the cell units includes a cathode current collector, an anode current collector, and a membrane electrode assembly (MEA) disposed between the cathode current collector and the anode current collector. The anode fuel supplying unit is disposed on a side of the anode current collector, and the cathode fuel supplying unit is disposed on a side of the cathode current collector. In addition, the heat-conductive material layer is disposed between the cathode current collector and the cathode fuel supplying unit and/or the anode current collector and the anode fuel supplying unit. Moreover, the heat-conductive material layer includes a first portion located in the cell system reaction area, and a second portion extending to the outside of the cell system reaction area along a direction parallel to the cell unit. The first portion of the heat-conductive material layer has at least one opening.

The present invention also provides a passive fuel cell system, including at least one first cell unit, at least one second cell unit, an anode fuel supplying unit, two cathode fuel supplying units, and two heat-conductive material layers. A cell system reaction area is defined by the first cell unit, the second cell unit, the two cathode fuel supplying units, and the anode fuel supplying unit. The first cell unit and the second cell unit each include a cathode current collector, an anode current collector, and an MEA disposed between the cathode current collector and the anode current collector. The anode fuel supplying unit is disposed between the anode current collectors of the first cell unit and the second cell unit. The two cathode fuel supplying units are respectively disposed on a side of the cathode current collector of the first cell unit and a side of the cathode current collector of the second cell unit. The heat-conductive material layers are respectively between the cathode current collectors and the cathode fuel supplying units of the first cell unit and the second cell unit and/or the anode current collectors and the anode fuel supplying units of the first cell unit and the second cell unit. Moreover, the heat-conductive material layer includes a first portion located in the cell system reaction area, and a second portion extending to the outside of the cell system reaction area along a direction parallel to the cell unit. The first portion of the heat-conductive material layer has at least one opening.

The present invention also provides a passive fuel cell system, including at least one first cell unit, at least one second cell unit, two anode fuel supplying units, a cathode fuel supplying unit, and two heat-conductive material layers. A cell system reaction area is defined by the first cell unit, the second cell unit, the two anode fuel supplying units, and the cathode fuel supplying unit. The first cell unit and the second cell unit each include a cathode current collector, an anode current collector, and an MEA disposed between the cathode current collector and the anode current collector. Moreover, the cathode current collectors of the first cell unit and the second cell unit are disposed opposite to each other. The two anode fuel supplying units are respectively disposed on a side of the anode current collector of the first cell unit and a side of the anode current collector of the second cell unit. The cathode fuel supplying unit is disposed between the cathode current collectors of the first cell unit and the second cell unit. The two heat-conductive material layers are respectively between the cathode current collectors and the cathode fuel supplying units of the first cell unit and the second cell unit and/or the anode current collectors and the anode fuel supplying units of the first cell unit and the second cell unit. Moreover, the heat-conductive material layer includes a first portion located in the cell system reaction area, and a second portion extending to the outside of the cell system reaction area along a direction parallel to the cell unit. The first portion of the heat-conductive material layer has at least one opening.

The passive fuel cell system of the present invention has the heat-conductive material layer disposed on a side of the cathode current collector and/or the anode current collector, and the heat-conductive material layer extends to the outside of the cell system reaction area. Therefore, the heat-conductive material layer may be used to transfer the high temperature inside the cell to a relative low temperature end, so as to effectively dissipate the waste heat generated in the working of the cell, such that the fuel cell keeps working in a stable working temperature range.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic structural view of a passive fuel cell system according to a first embodiment of the present invention.

FIG. 2 is a schematic structural view of a passive fuel cell system according to a second embodiment of the present invention.

FIG. 3 is a schematic structural view of a passive fuel cell system according to a third embodiment of the present invention.

FIG. 4 is a schematic structural view of a passive fuel cell system according to a fourth embodiment of the present invention.

FIG. 5 is a schematic structural view of a passive fuel cell system according to a fifth embodiment of the present invention.

FIG. 6 is a schematic structural view of a passive fuel cell system according to a sixth embodiment of the present invention.

FIG. 7 is a schematic structural view of a passive fuel cell system according to a seventh embodiment of the present invention.

FIG. 8 is a schematic structural view of a passive fuel cell system according to an eighth embodiment of the present invention.

### DESCRIPTION OF EMBODIMENTS

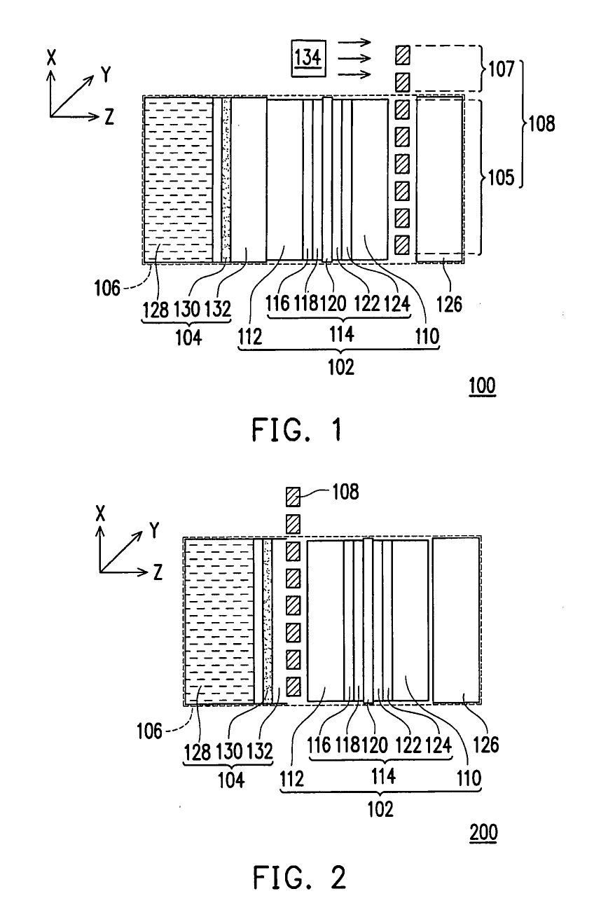

FIG. 1 is a schematic structural view of a passive fuel cell system according to a first embodiment of the present invention.

Referring to FIG. 1, the passive fuel cell system 100 includes a cell unit 102, an anode fuel supplying unit 104, a cathode fuel supplying unit 126, and a heat-conductive material layer 108. A cell system reaction area 106 is defined by the cell unit 102, the cathode fuel supplying unit 126 and the anode fuel supplying unit 104. The cell system reaction area 106, for example, can be formed by sealing the cell unit 102, the cathode fuel supplying unit 126, and the anode fuel supplying unit 104 with a sealant. The material of the sealing material layer, for example, is an adhesive such as silicone or epoxy resin, and is used to prevent the leakage of the cathode fuel and anode fuel from influencing the performance of the battery. In addition, the cell system reaction area 106 may also be formed by covering the cell unit 102, the cathode fuel supplying unit 126, and the anode fuel supplying unit 104 with a case. The material of the case, for example, is a polymer having thermal resistance at a high temperature of over 90° C., such as polypropylene (PP), polycarbonate (PC), polyethersulfone (PES), and polyetheretherketone (PEEK), or a light metal such as aluminum (Al) or magnesium (Mg).

The cell unit 102 of the passive fuel cell system 100 mainly includes a cathode current collector 110, an anode current collector 112, and a membrane electrode assembly (MEA) 114. The MEA 114 is disposed between the cathode current collector 110 and the anode current collector 112, and includes an anode gas diffusion layer 116, an anode catalyst layer 118, a proton conduction membrane 120, a cathode catalyst layer 122, and a cathode gas diffusion layer 124. The materials of the cathode current collector 110, the anode current collector 112, and the MEA 114 are known to persons of ordinary skill in the art, and will not be described herein again.

In addition, the anode fuel supplying unit 104 of the passive fuel cell system 100 is disposed on a side of the anode current collector 112, and the cathode fuel supplying unit 126 is disposed on a side of the cathode current collector 110. The anode fuel supplying unit 104, for example, includes a fuel tank 128 for storing liquid fuel. The space encircled by the anode current collector 112, the fuel tank 128, and a portion of the cell system reaction area 106 is used as a storage chamber 132 for accommodating vaporized fuel. For example, a gas-liquid separation membrane 130 may be disposed in the anode fuel supplying unit 104, for separating the liquid fuel to obtain the vaporized fuel. The composition of the anode fuel supplying unit 104 and the cathode fuel supplying unit 126 is not particularly limited in the present invention, and may be fuel supplying units of ordinary fuel cells.

Usually, the waste heat is generated in the period of the working of the fuel cell. If the waste heat cannot be dissipated effectively, the working of the fuel cell will be influenced. For example, the working temperature of the fuel cell becomes very high, which results in excessive amount of the vaporized fuel of the anode, leading to the fuel crossover effect, lower output power, and shorter lifespan of the cell.

The passive fuel cell system of the present invention further includes the heat-conductive material layer 108, such that the fuel cell keeps working in the stable working temperature range. The heat-conductive material layer of the present invention will be illustrated in detail below.

Referring to FIG. 1 again, the heat-conductive material layer 108 is disposed between the cathode current collector 110 and the cathode fuel supplying unit 126. The material of the heat-conductive material layer 108 may be graphite, or a metal having good thermal conductivity, such as copper (Cu), aluminum, or magnesium. The heat-conductive material layer 108 may be a heat pipe, so as to conduct the heat more rapidly. In this embodiment, the heat-conductive material layer 108 includes a first portion 105 located in the cell system reaction area 106 and a second portion 107 disposed outside the cell system reaction area 106. The first portion 105 of the heat-conductive material layer 108 has at least one opening which is a through hole, for example. The through hole is a closed opening and with an opening ratio of 0.1%˜70%. The defined of the opening ratio represents a ratio between a surface area of the opening and a total surface area of the heat-conductive material layer 108. The second portion 107 of the heat-conductive material layer 108 extends to the outside of the cell system reaction area 106 along a direction parallel to the cell unit 102. That is to say, the heat-conductive material layer 108 is disposed on a plane X-Y parallel to the cell unit 102.

It should be noted that when the cell works, the waste heat generated in the inside of the cell is conducted to a relatively low temperature end through the heat-conductive material layer 108. The relatively low temperature end, for example, is the atmosphere outside the cell system reaction area 106. In particular, the heat-conductive material layer 108 is disposed on the plane X-Y parallel to the cell unit 102, so most of the waste heat inside the cell will be transferred in a path toward the plane X-Y. In this manner, the working temperature of the cell is maintained stable, and the conventional problem that the fuel supply of the cathode side is influenced by the heat dissipation inside the cell in the conventional art is avoided.

In addition, the heat-conductive material layer 108 of this embodiment extends to the outside of the cell system reaction area 106 along the plane X-Y parallel to the cell unit 102, so as to dissipate the waste heat. In addition to solving the problems induced by the waste heat of the cell that is not effectively dissipated in the conventional arts, the passive fuel cell system of this embodiment will not influence the temperature of the MEA and the output power, and will not increase the size of the overall system and the complexity to fabricate the system as well.

In one embodiment, a heat sink (not shown) may be further disposed on the second portion 107 of the heat-conductive material layer 108. The heat sink is useful to dissipating the heat of the fuel cell, and further improves the stability of the working temperature of the fuel cell.

Moreover, in another embodiment, a heat dissipation equipment 134 may be used to dissipate the waste heat to the outside of the cell system reaction area 106 via the heat-conductive material layer 108, so as to lower the temperature through convection. The heat dissipation equipment 134, for example, is a fan or other appropriate heat dissipation equipments. When the temperature of the fuel cell is too high to use the heat-conductive material layer 108 and the heat sink only to stabilize and control the temperature, the heat dissipation equipment 134 helps to continually conduct the waste heat inside the cell to the outside without influencing the performance of the fuel cell.

In this embodiment, the heat-conductive material layer of the passive fuel cell system is, for example, the heat-conductive material layer having the through hole. However, the present invention is not limited to this. In other embodiments, the opining of the first portion of the heat-conductive material layer in the present invention is, for example, approximately in a comb shape (not shown). The opining of the first portion of the heat-conductive material layer is also other non-closed opening, as long as the fuel flow amount of the electrodes are sufficient for the fuel cell to generate electricity. In addition, the second portion of the heat-conductive material layer, for example, may have or not have openings, which is not particularly limited herein.

Then, embodiments of the passive fuel cell system as shown in FIGS. 2 to 8 are described to illustrate the present invention in detail. In FIGS. 2 to 8, the heat-conductive material layer is the heat-conductive material layer having the through hole.

FIG. 2 is a schematic structural view of a passive fuel cell system according to a second embodiment of the present invention. As shown in FIG. 2, the passive fuel cell system 200 of this embodiment is similar to the passive fuel cell system 100 of the first embodiment, and only the main difference is described as follows. In the passive fuel cell system 200, the heat-conductive material layer 108 is disposed between the anode current collector 112 and the anode fuel supplying unit 104.

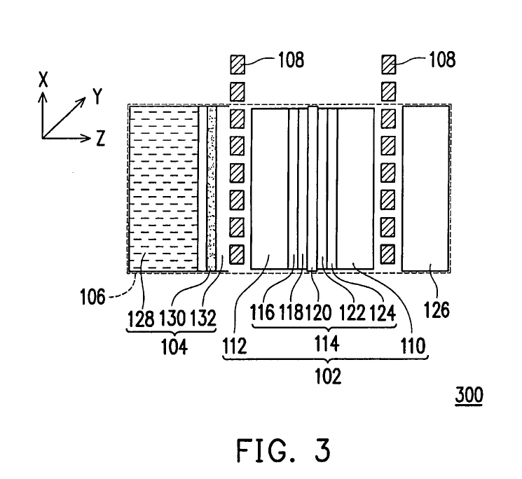

FIG. 3 is a schematic structural view of a passive fuel cell system according to a third embodiment of the present invention. As shown in FIG. 3, the passive fuel cell system 300 of this embodiment is similar to the passive fuel cell system 100 of the first embodiment, and only the main difference is described as follows. In the passive fuel cell system 300, in addition to the heat-conductive material layer 108 disposed between the cathode current collector 110 and the cathode fuel supplying unit 126, another heat-conductive material layer is also disposed between the anode current collector 112 and the anode fuel supplying unit 104.

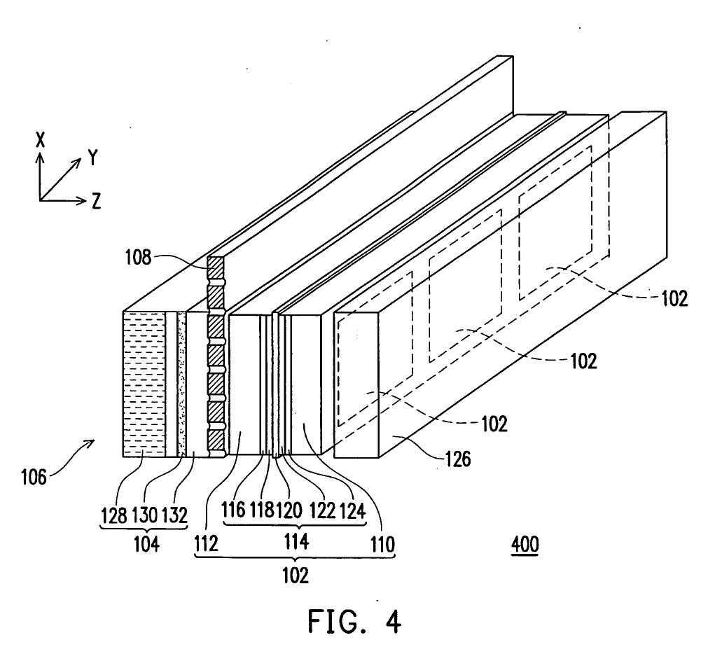

FIG. 4 is a schematic structural view of a passive fuel cell system according to a fourth embodiment of the present invention. As shown in FIG. 4, the passive fuel cell system 400 of this embodiment is similar to the passive fuel cell system 100, 200 and 300 of the first, second and third embodiments, and only the main difference is described as follows. The passive fuel cell system 400 includes a plurality of cell units 102 connected in series. In the fourth embodiment, the heat-conductive material is for example disposed between the anode current collector and the anode fuel supplying unit 104 and the number of the cell units are for example three. However, the number of the cell units is not particularly limited in the present invention.

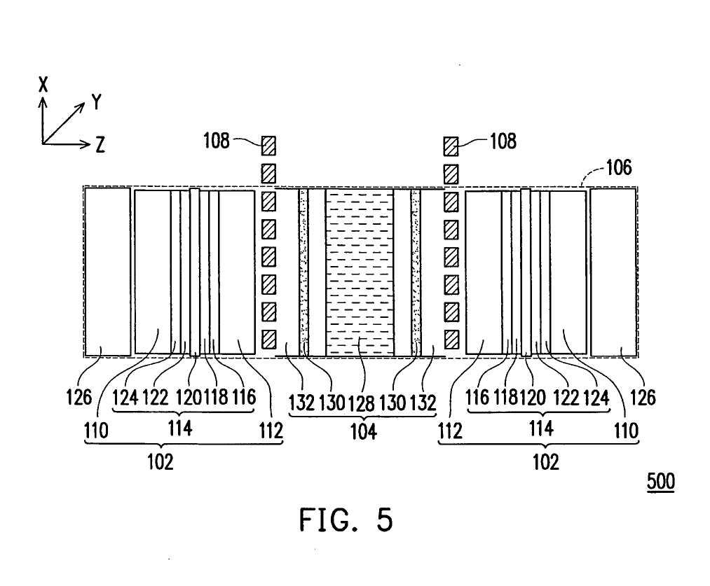

In addition to the above embodiments, the passive fuel cell system of the present invention can be implemented in other modes. Hereinafter, other passive fuel cell systems of the present invention will be illustrated with reference to FIGS. 5 to 8. The same reference numbers are used in the FIGS. 5 to 8 and the description refer to the same or like parts in FIG. 1, and the description of the same parts will be omitted.

FIG. 5 is a schematic structural view of a passive fuel cell system according to a fifth embodiment of the present invention. As shown in FIG. 5, in the passive fuel cell system 500, a cell unit 102 is disposed on each of the two sides of the anode fuel supplying unit 104. The anode current collectors 112 of the two cell units 102 both face the anode fuel supplying unit 104, and the anode fuel supplying unit 104 is shared by the two cell units 102. Moreover, a heat-conductive material layer 108 is disposed on a side of the anode current collector 112 of each of the two cell units 102.

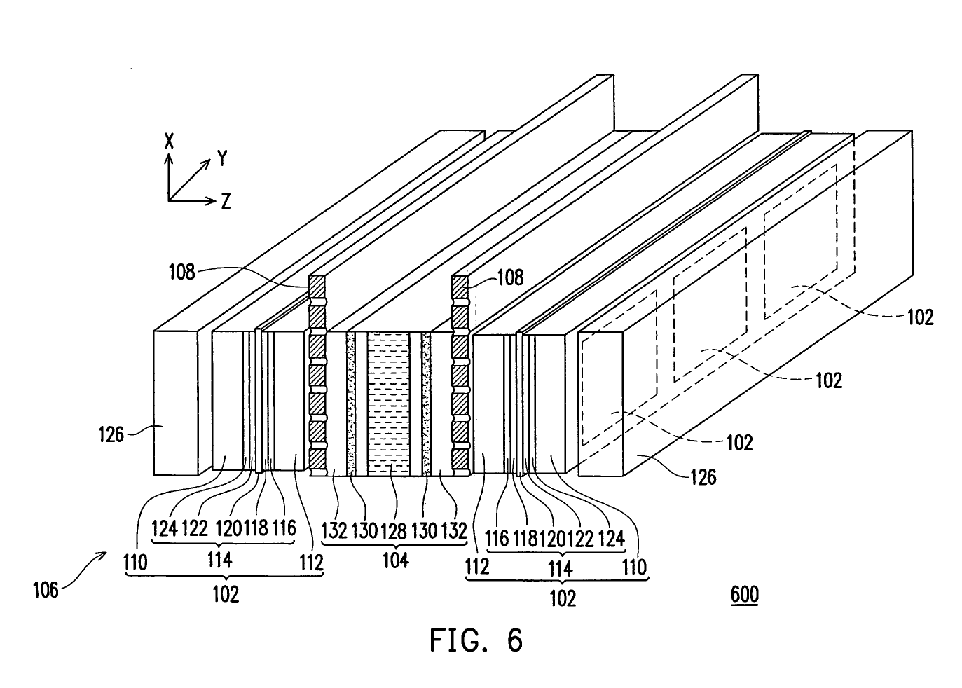

FIG. 6 is a schematic structural view of a passive fuel cell system according to a sixth embodiment of the present invention. As shown in FIG. 6, the passive fuel cell system 600 of this embodiment is similar to the passive fuel cell system 500 of the fifth embodiment, and only the main difference is described as follows. In the passive fuel cell system 600, a plurality of cell units 102 connected in series is disposed on each of two sides of the anode fuel supplying unit 104. In the sixth embodiment, the number of the cell units is for example six. However, the number of the cell units is not particularly limited in the present invention.

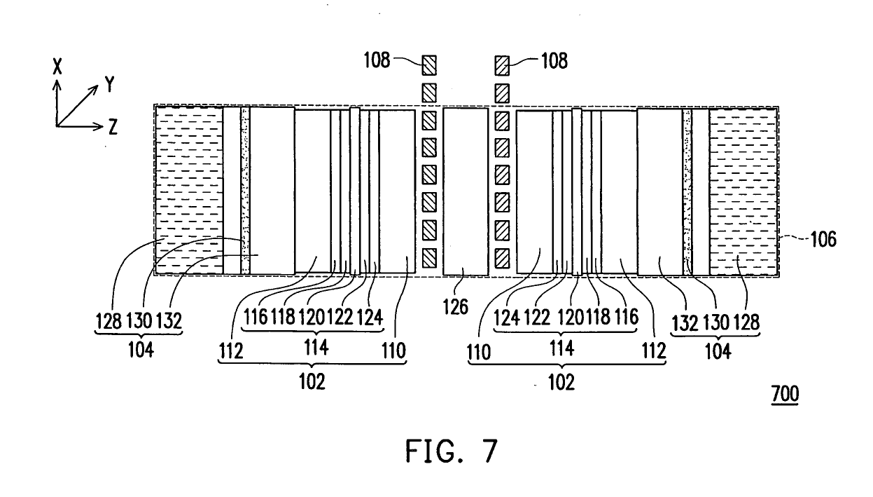

FIG. 7 is a schematic structural view of a passive fuel cell system according to a seventh embodiment of the present invention. As shown in FIG. 7, the passive fuel cell system 700 includes two cell units 102, and the cathode current collectors 110 of the two cell units 102 are disposed opposite to each other. An anode fuel supplying unit 104 is disposed on a side of the anode current collector 112 of each of the two cell units 102. Moreover, a heat-conductive material layer 108 is disposed on a side of the cathode current collector 112 of each of the two cell units 102.

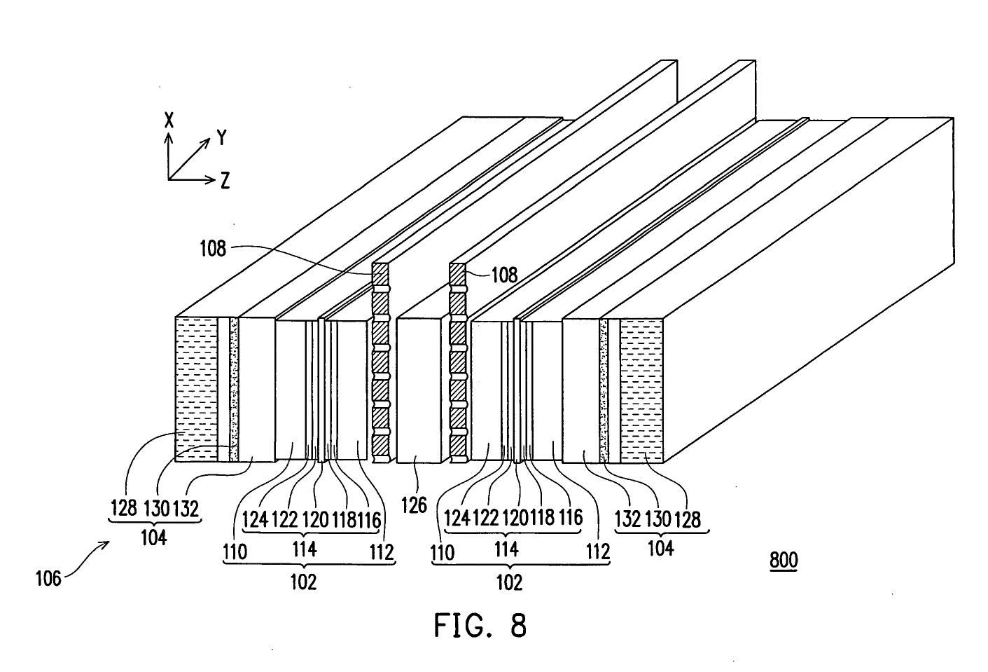

FIG. 8 is a schematic structural view of a passive fuel cell system according to an eighth embodiment of the present invention. As shown in FIG. 8, the passive fuel cell system 800 of this embodiment is similar to the passive fuel cell system 700 of the seventh embodiment, and only the main difference is described as follows. In the passive fuel cell system 800, a plurality of cell units 102 connected in series is disposed on a side of each of the anode fuel supplying units 104. In the eighth embodiment, the number of the cell units is for example six. However, the number of the cell units is not particularly limited in the present invention.

In another aspect, the heat-conductive material layers of the passive fuel cell systems 500, 600, 700 or 800, for example, may also be disposed on a side of the cathode current collectors 110 of the two cell units 102. Or, the heat-conductive material layers of the passive fuel cell systems 500, 600, 700 or 800, for example, may also be disposed on a side of the cathode current collector 110 of one cell unit 102 and a side of the anode current collector 112 of another cell unit 102. Or, the heat-conductive material layers of the passive fuel cell systems 500, 600, 700 or 800, for example, may also be disposed on a side of the cathode current collector 110 and a side of the anode current collector 112 of one cell unit 102, and on a side of the cathode current collector 110 or a side of the anode current collector 112 of another cell unit 102. Or, the heat-conductive material layers of the passive fuel cell systems 500, 600, 700 or 800, for example, may also disposed on a side of the cathode current collector 110 and a side of the anode current collector 112 of each of the two cell units 102.

Then, the practical test data of the passive fuel cell system of the present invention is listed in Table 1 below. Table 1 shows the test results of Comparative Examples 1-2 and Experimental Examples 1-2. Comparative Examples 1-2 are tests on a passive fuel cell assembly without the heat-conductive material layer 108, and Experimental Examples 1-2 are tests on a passive fuel cell assembly having the heat-conductive material layer 108.

TABLE 1

| | Arrangement of cell | Heat-conductive | Ambient | System balance |
|---|---|---|---|---|
| | units | material layer | temperature (° C.) | temperature (° C.) |
| Comparative | Anode inside (as | No | 23 | 65 |
| Example 1 | shown in FIG. 5) | | | |
| Comparative | Cathode inside (as | No | 23 | 53 |
| Example 2 | shown in FIG. 7) | | | |
| Experimental | Anode inside (as | Yes | 23 | 38 |
| Example 1 | shown in FIG. 5) | | | |
| Experimental | Cathode inside (as | Yes | 23 | 46 |
| Example 2 | shown in FIG. 7) | | | |

It is known from the test results of Comparative Example 1 and Experimental Example 1 that the heat-conductive material layer 108 disposed on the anode side can dissipate the waste heat near the anode fuel supplying unit 104, so as to reduce the temperature of the anode fuel supplying unit 104, prevent the excessive vaporization of methanol fuel, and effectively maintain the system temperature at about 38° C.

Moreover, it is known from the test results of Comparative Example 2 and Experimental Example 2 that the heat-conductive material layer 108 disposed on the cathode side can also reduce the system balance temperature. However, as the heat-conductive material layer 108 is disposed on the cathode side in Experimental Example 2, the temperature of the anode fuel supplying unit 104 will be higher than that of Experimental Example 1. Therefore, the vaporization amount of methanol fuel is higher, and the system balance temperature is also slightly higher than that of Experimental Example 1.

It is known from the above experiments that the heat-conductive material layer disposed in the passive fuel cell system can effectively dissipate the waste heat inside the cell. In addition, if the passive fuel cell system includes the heat-conductive material layer and the heat dissipation equipment, the temperature of the passive fuel cell system can be effectively controlled by controlling the ON/OFF of the heat dissipation equipment and the output power of the heat dissipation equipment.

To sum up, the passive fuel cell system of the present invention can effectively dissipate the waste heat generated in the working of the cell, so as to maintain the working temperature of the cell in a stable range. Further, the heat-conductive material layer of the present invention does not influence the temperature of the MEA and the output power, and does not influence the water recycling efficiency of the cathode end. In another aspect, the present invention will not increase the volume of the overall system, and the complexity of fabricating the system.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A passive fuel cell system, comprising:
at least one cell unit, comprising:
a cathode current collector;
an anode current collector; and
a membrane electrode assembly (MEA), disposed between the cathode current collector and the anode current collector;
an anode fuel supplying unit, disposed on a side of the anode current collector;
a cathode fuel supplying unit, disposed on a side of the cathode current collector,
wherein a cell system reaction area is defined by the cell unit, the anode fuel supplying unit, and the cathode fuel supplying unit; and
a heat-conductive material layer, disposed between the cathode current collector and the cathode fuel supplying unit and/or between the anode current collector and the anode fuel supplying unit, the heat-conductive material layer comprising a first portion located in the cell system reaction area and a second portion extending to the outside of the cell system reaction area in a direction parallel to the cell unit, wherein the first portion of the heat-conductive material layer has at least one opening.

2. The passive fuel cell system as claimed in claim 1, further comprising a heat sink disposed on the second portion of the heat-conductive material layer.

3. The passive fuel cell system as claimed in claim 1, further comprising a heat dissipation equipment disposed around the second portion of the heat-conductive material layer.

4. The passive fuel cell system as claimed in claim 1, wherein the opening of the first portion of the heat-conductive material layer is a through hole and with an opening ratio of 0.1%˜70%.

5. The passive fuel cell system as claimed in claim 1, wherein a material of the heat-conductive material layer comprises graphite or metal.

6. The passive fuel cell system as claimed in claim 1, wherein the heat-conductive material layer is further attached with heat pipe.

7. The passive fuel cell system as claimed in claim 1, further comprising a plurality of cell units connected in series, wherein the anode current collectors of the cell units are disposed facing the anode fuel supplying unit.

8. A passive fuel cell system, comprising:
at least one first cell unit and at least one second fuel unit, each comprising:
a cathode current collector;
an anode current collector; and
an MEA, disposed between the cathode current collector and the anode current collector;
an anode fuel supplying unit, disposed between the anode current collectors of the first cell unit and the second cell unit;
two cathode fuel supplying units, respectively disposed on a side of the cathode current collector of the first cell unit and a side of the cathode current collector of the second cell unit,
wherein a cell system reaction area is defined by the first cell unit, the second cell unit, the two cathode fuel supplying units, and the anode fuel supplying unit; and
two heat-conductive material layers, respectively disposed between the cathode current collectors and the cathode fuel supplying units of the first cell unit and the second cell unit and/or the anode current collectors and the anode fuel supplying units of the first cell unit and the second cell unit, and each of the heat-conductive material layers comprising a first portion located in the cell system reaction area and a second portion extending to the outside of the cell system reaction area in a direction parallel to the cell unit, wherein the first portion of each of the heat-conductive material layers has at least one opening.

9. The passive fuel cell system as claimed in claim 8, further comprising a heat sink disposed on the second portion of each of the heat-conductive material layers.

10. The passive fuel cell system as claimed in claim 8, further comprising a heat dissipation equipment disposed around the second portion of each of the heat-conductive material layers.

11. The passive fuel cell system as claimed in claim 8, wherein the opening of the first portion of the heat-conductive material layers is a through hole and with an opening ratio of 0.1%˜70%.

12. The passive fuel cell system as claimed in claim 8, wherein a material of the heat-conductive material layers comprises graphite or metal.

13. The passive fuel cell system as claimed in claim 8, wherein the heat-conductive material layer is further attached with heat pipe.

14. The passive fuel cell system as claimed in claim 8, further comprising a plurality of first cell units connected in series and a plurality of second cell units connected in series respectively disposed on two sides of the anode fuel supplying unit, wherein the anode current collectors of the first cell units and the second cell units are disposed facing the anode fuel supplying unit.

15. A passive fuel cell system, comprising:
at least one first cell unit and at least one second cell unit, each comprising:
a cathode current collector;
an anode current collector; and
an MEA, disposed between the cathode current collector and the anode current collector,
wherein the cathode current collectors of the first cell unit and the second cell unit are disposed opposite to each other;
two anode fuel supplying units, respectively disposed on a side of the anode current collector of the first cell unit and a side of the anode current collector of the second cell unit;
a cathode fuel supplying unit, disposed between the cathode current collectors of the first cell unit and the second cell unit,
wherein a cell system reaction area is defined by the first cell unit, the second cell unit, the cathode fuel supplying unit, and the two anode fuel supplying units; and
two heat-conductive material layers, respectively disposed between the cathode current collectors and the cathode fuel supplying units of the first cell unit and the second cell unit and/or the anode current collectors and the anode fuel supplying units of the first cell unit and the second cell unit, and each of the heat-conductive material layers comprising a first portion located in the cell system reaction area and a second portion extending to the outside of the cell system reaction area in a direction parallel to the cell unit, wherein the first portion of each of the heat-conductive material layers has at least one opening.

16. The passive fuel cell system as claimed in claim 15, further comprising a heat sink disposed on the second portion of each of the heat-conductive material layers.

17. The passive fuel cell system as claimed in claim 15, further comprising a heat dissipation equipment disposed around the second portion of each of the heat-conductive material layers.

18. The passive fuel cell system as claimed in claim 15, wherein the opening of the first portion of the heat-conductive material layers is a through hole and with an opening ratio of 0.1%˜70%.

19. The passive fuel cell system as claimed in claim 15, wherein a material of the heat-conductive material layers comprises graphite or a metal.

20. The passive fuel cell system as claimed in claim 15, wherein the heat-conductive material layer is further attached with a heat pipe.

21. The passive fuel cell system as claimed in claim 15, further comprising a plurality of first cell units connected in series and a plurality of second cell units connected in series, wherein the cathode current collectors of the first cell units and the second cell units are disposed opposite to each other.
